(19) United States
(12) Patent Application Publication
(10) Pub. No.: US 2024/0360389 A1
(43) Pub. Date: Oct. 31, 2024

(54) Dishwashing detergents and use thereof

(71) Applicant: Catexel GmbH, Wiesbaden (DE)

(72) Inventors: Yifei Zhan, Wiesbaden (DE); Judith Preuschen, Sörgenloch (DE)

(21) Appl. No.: 18/626,852

(22) Filed: Apr. 4, 2024

(30) Foreign Application Priority Data
Apr. 27, 2023 (DE) 20 2023 000 933.2

(51) Int. Cl. C11D 3/39; C11D 1/72; C11D 3/08; C11D 3/10; C11D 3/20; C11D 3/22; C11D 3/37; C11D 3/386; C11D 17/00

(52) U.S. Cl. CPC C11D 3/392; C11D 1/72; C11D 3/08; C11D 3/10; C11D 3/2086; C11D 3/225; C11D 3/3707; C11D 3/3761; C11D 3/38609; C11D 3/3942; C11D 17/0039

(57) ABSTRACT

Disclosed are dishwashing detergents containing the components
a) 10-90% by weight of at least one builder
b) 0.1-20% by weight of at least one bleach activator
c) 0.1-20% by weight of at least one non-ionic surfactant
d) 5-40% by weight of at least one oxygen-containing bleaching agent
e) 0.1-80% by weight of at least one pH regulator, and
f) 0.1-5% by weight of at least one sulfonimine as bleaching catalyst,
   with the proviso that the dishwashing detergent does not contain any anionic surfactant and that the percentages relate to the total amount of the dishwashing detergent.

These dishwashing detergents may be used for removing red and/or yellow soiling from bathroom or kitchen articles, preferably from plastic articles.

### CLAIM FOR PRIORITY

This application is a national phase application of DE application 20 2023 000 933.2 filed Apr. 27, 2023, the priority of which is hereby claimed and its disclosure incorporated herein by reference.

### FIELD OF THE INVENTION

The present invention relates to dishwashing detergents which are particularly suitable for removing hydrophobic red and yellow soilings from dishes, and to the use of these detergents, in particular in automatic dishwashing.

### BACKGROUND OF THE INVENTION

Modern automatic dishwashing detergents have to meet a wide range of requirements. They should demonstrate improved cleaning and rinsing performance, even in low-temperature wash cycles or in wash cycles with reduced water consumption. Particular attention is paid to the drying properties of the automatic dishwashing detergents used. The need for additional manual drying of the cleaned dishes is undesirable; dripping and residues on the treated dishes should be avoided.

Red and yellow stains on dishes, especially on plastic items, such as residues from tomatoes or ketchup as well as from dishes containing curry, turmeric or saffron, have proven to be particularly stubborn. In many cases, it is not possible to remove these strongly staining components from plastic items; after treatment in the dishwasher, they often still have residues that cannot be removed even by subsequent wash cycles.

There have already been attempts to improve the removal of strongly staining contaminants from plastic tableware. For example, GB 2 389 856 A discloses such a process in which an aqueous alkaline solution with a peroxide value in the range from 0.05 to 40, determined according to Wheeler, is used. This peroxide value is achieved by using terpenes in the lye. These additives have not yet found their way into commercially available dishwashing detergents. It therefore remains a problem to remove strongly staining red and yellow soilings from dishes and especially plastic dishes.

Strongly bleaching additives, such as sulfonimines, have already been proposed for use in detergents in the past. For example, WO 2022/069468 A1 discloses a detergent for removing soilings or foul odors from textiles. This detergent contains a bleaching agent, a bleach activator, a protease and an oxygen transfer agent, such as 3-methyl-1,2-benzisothiazole-1,1-dioxide. The use of this product for cleaning dishes is not described.

US 2021/0277333 A1 describes cogranulates that are used in detergents and cleaning agents. These cogranulates are coated with cellulose ether and contain cyclic sulfonimine, bleach activator and cellulose ether as binders. The use in dishwashing detergents is not disclosed.

EP 3345989 A1 discloses granules which can be used in detergents and cleaning agents as well as in dishwashing detergents. These granules contain sulfonimines or quaternary iminium salts and acids which are solid at 25° C. The granules are characterized by high storage stability, contain highly active bleaching catalysts and develop a very good bleaching effect even at low temperatures. Examples of dishwashing detergents are not included in this document.

Detergents and dishwashing detergents differ in their composition. Although a number of components with the same composition can be used in these agents, they differ significantly from each other. For example, only non-ionic surfactants are used in dishwashing detergents, whereas laundry detergents generally contain anionic and non-ionic surfactants. Dishwashing detergents also often contain special additives, such as glass corrosion inhibitors, silver corrosion inhibitors or foam regulators.

### SUMMARY OF THE INVENTION

The objective of the present invention was to provide dishwashing detergents that are ideal for removing red and yellow stains from dishes. In addition to their excellent cleaning performance, these agents also have an outstanding bleaching effect, making it possible to remove color residues from objects that are already stained red or yellow.

Surprisingly, it has now been found that dishwashing detergents containing sulfonimines and other selected ingredients have a particularly good cleaning performance when removing red and yellow stains from dishes.

The present invention relates to a dishwashing detergent comprising the components
a) 10-90% by weight of at least one builder
b) 0.1-20% by weight of at least one bleach activator
c) 0.1-20% by weight of at least one non-ionic surfactant
d) 5-40% by weight of at least one oxygen-containing bleaching agent
e) 0.1-80% by weight of at least one pH regulator, and
f) 0.1-5% by weight of at least one sulfonimine as bleaching catalyst,
   with the proviso that the dishwashing detergent does not contain substantially any anionic surfactant and that the percentages relate to the total amount of the dishwashing detergent.

### DETAILED DESCRIPTION OF THE INVENTION

As builders or structural materials all compounds previously used in dishwashing detergents can be used in the invention,

Examples of builders are phosphates such as pentasodium triphosphate. Since phosphates contribute to the eutrophication of bodies of water, water-soluble organic compounds are preferably used today. These do not replace all the functions of phosphates and are therefore often used together with polycarboxylates, nitriloacetic acid, phosphonates, soda or complexing carboxylic acids, such as salts of citric acid.

Preferably used builders contain at least 10% by weight, based on the total amount of builder, of crystalline sodium layered silicate of the formula (I)

Na₂SiₓO₂ₓ₊₁·y H₂O (I)

wherein x is a number from 1.9 to 4 and y is a number from 0 to 20,

Crystalline layered silicates according to formula (I) are described, for example, in the European patent application with the laid-open number EP 0 164 514 A1.

Preferred crystalline layered silicates are those in which x in the general formula mentioned above assumes the values from 1.9 to 3.5.

In particular, both delta and beta disodium disilicates (Na₂Si₂O₅·y H₂O) are preferred, wherein beta disodium disilicate can be obtained, for example, by the process described in WO 91/08171 A1. Beta disodium silicates with a molar ratio of SiO₂/Na₂O between 1.9 and 3.2 can be produced according to the Japanese patent applications with the laid-open numbers JP 04/238 809 A or JP 04/260 610 A. Practically anhydrous crystalline alkali silicates produced from amorphous silicates of the above-mentioned general formula (I), in which x is a number from 1.9 to 2.1, can also be used.

In a preferred form, the crystalline layered disodium disilicate of builder a) is assembled of alternating percentages of the polymorphic phases alpha, beta and delta. Commercially manufactured products may also contain amorphous components. Due to the latter, x can also be odd in commercial products. Preferred is 1.9≤x≥2.2.

The definitions of alpha, beta and delta disodium disilicate are known and can be found, for example, in EP 0 164 514 A1.

Preferably, the disodium disilicate is a layered crystalline disodium disilicate comprising at least one of the polymorphic phases of the disodium disilicate and of sodium silicates of a non-layered silicate nature.

In particular, crystalline sodium layered silicates with a content of 80 to 100% by weight of delta disodium disilicate are preferred.

In a further preferred variant, crystalline sodium layered silicates with a content of 70 to 100% by weight of beta-disodium disilicate can also be used.

Particularly preferred crystalline sodium layered silicates contain 1 to 40% by weight of alpha disodium disilicate, 0 to 50% by weight, in particular 0 to 45% by weight of beta disodium disilicate, 50 to 98% by weight of delta disodium disilicate and 0 to 40% by weight of non-layered silicate sodium silicates (amorphous fractions).

In a further preferred embodiment of the invention, the dishwashing compositions according to the invention contain crystalline sodium layered silicate of formula (I) in granulated form, as well as cogranulates containing crystalline sodium layered silicate and sparingly soluble metal carbonate, as described, for example, in WO2007/101622 A1.

In another preferred embodiment of the invention, the dishwashing detergents according to the invention contain crystalline sodium disilicates Na₂Si₂O₅·y H₂O with y equal to 0 to 2.

In addition to crystalline sodium layered silicate according to formula (I), the dishwashing detergents according to the invention may contain further water-soluble organic and/or inorganic builders.

Alkali silicates and polymeric alkali phosphates, which may be present in the form of their alkaline, neutral or acidic sodium or potassium salts, are particularly suitable as water-soluble inorganic builder materials. Examples of these are trisodium phosphate, tetrasodium diphosphate, disodium dihydrogen diphosphate, pentasodium triphosphate, so-called sodium hexametaphosphate and the corresponding potassium salts or mixtures of sodium and potassium salts.

The water-soluble organic builder substances include polycarboxylic acids or their salts, in particular citric acid and sugar acids, aminopolycarboxylic acids, in particular methylglycine-diacetic acid or its salt (MGDA), glutamic di-acetic acid or its salt (GLDA), iminodisuccinic acid (IDS) and ethylenediaminedisuccinic acid or its salt (EDDS), nitrilotriacetic acid and ethylenediaminetetraacetic acid as well as polyaspartic acid. polyphosphonic acids, in particular aminotris(methylenephosphonic acid), ethylenediaminetetrakis(methylenephosphonic acid) and 1-hydroxyethane-1,1-diphosphonic acid, can also be used. Preferred builders or co-builders are also polycarboxylic acids, in particular the polycarboxylates accessible by oxidation of polysaccharides or dextrins, as described in WO 93/16110 A1, WO 92/18542 A1 or EP 0 232 202 A2, as well as polymeric acrylic acids, methacrylic acids, AMPS, maleic acids and mixed polymers of these, which can also contain small proportions of polymerizable substances without carboxylic acid functionality in polymerized form. According to the manufacturer, the average molecular weight of the homopolymers of unsaturated carboxylic acids, expressed as M_{w}, is generally between 2000 and 200,000, that of the copolymers between 2000 and 200,000, preferably between 50,000 and 120,000, in each case based on free acid.

A particularly preferred homopolymer is Sokalan PA 30 from BASF. A particularly preferred acrylic acid/maleic acid copolymer has an average molecular weight of 50,000 to 100,000. Commercially available products are, for example, Sokalan® CP 5 and Sokalan® CP 10 from BASF.

Also suitable are copolymers of acrylic acid or methacrylic acid with AMPS, vinyl ethers, such as vinyl methyl ethers, vinyl esters, ethylene, propylene and styrene, in which the proportion of acid is at least 50% by weight. Terpolymers which contain two unsaturated acids and/or their salts as monomers and vinyl alcohol and/or an esterified vinyl alcohol or a carbohydrate as a third monomer can also be used as water-soluble organic builder substances. The first acidic monomer or its salt is derived from a monoethylenically unsaturated C₃-C₈ carboxylic acid, preferably from a C₃-C₄ monocarboxylic acid, in particular from (meth) acrylic acid, wherein the second acidic monomer or its salt can be a derivative of a C₂-C₆ dicarboxylic acid, maleic acid and AMPS being particularly preferred, and/or a derivative of an allylsulfonic acid which is substituted in the 2-position with an alkyl or aryl radical. Such polymers can be prepared in particular by processes described in the German patent documents DE 42 21 381 and DE 43 00 772 and generally have a relative molecular mass of between 1.000 and 200.000. Other preferred copolymers are those described in the German patent applications with the laid-open number DE 43 03 320 A1 and DE 44 17 734 A1 and preferably have acrolein and acrylic acid/acrylic acid salts or vinyl acetate as monomers.

The organic builder substances can be used, in particular for the preparation of liquid agents, in the form of aqueous solutions, preferably in the form of 30 to 50% by weight aqueous solutions. All the acids mentioned are generally used in the form of their water-soluble salts, in particular their alkali salts.

In addition to polyphosphonates and phosphonate alkyl carboxylates, other possible water-soluble builder components are, for example, organic polymers of native or synthetic origin of the above-mentioned polycarboxylate type, which act as co-builders particularly in hard water regions, and naturally occurring hydroxycarboxylic acids such as mono-, dihydroxy succinic acid, alpha-hydroxypropionic acid and gluconic acid.

Similarly, the salts of citric acid, in particular sodium citrate, both anhydrous trisodium citrate and trisodium citrate dihydrate can also be used.

The dishwashing detergents according to the invention exhibit a pronounced cleaning capacity if, in addition to crystalline phyllosilicate of formula (I), they additionally contain builders selected from methyl glycine diacetic acid or salts thereof, sodium gluconate, IDS, sodium tripolyphosphate (STTP) and/or sodium citrate.

The dishwashing detergents according to the invention contain one or more builders in an amount of 10 to 90% by weight, preferably 15 to 70% by weight, more preferably 20 to 60% by weight, and most preferably 30 to 55% by weight, in each case based on the total weight of the dishwashing detergents according to the invention.

In addition to builders a), the dishwashing detergents according to the invention contain bleach activators b). These are compounds that release peroxocarboxylic acids under perhydrolysis conditions.

Suitable bleach activators contain O- and/or N-acyl groups.

Preferably, the dishwashing detergents according to the invention contain acylated alkylenediamines, in particular tetraacetylethylenediamie (TAED), acylated glycolurils, in particular tetraacetylglycoluril (TAGU), acylated triazine derivatives, in particular 1,5-diacetyl-2,4-dioxohexahydro-1,3,5-triazine (DADHT), acylated phenylsulfonates, in particular nonanoyl-, isononanoyl- or lauroyloxybenzenesulfonate (NOBS, ISONOBS or LOBS) or their amido derivatives (e.g. NACAOBS), acylated hydroxycarboxylic acids such as acetylsalicylic acid or nonanoyloxybenzoic acid (NOBA) and decanoyloxy-benzoic acid (DOBA), acetyl triethylcitrate, acylated polyhydric alcohols, in particular triacetin, ethylene glycol diacetate and 2,5-diacetoxy-2,5-dihydrofuran as well as acetylated sorbitol and mannitol, and acylated sugar derivatives, in particular pentaacetylglucose (PAG), pentaacetylfructose, tetraacetylxylose and octaacetyllactose as well as acetylated, optionally N-alkylated glucamine and gluconolactone, as well as N-acetylcaprolactam, N-benzoylcaprolactam and 4-morpholinecarbonitrol.

Open-chain or cyclic nitrile quats and the combinations of bleach activators known from DE-A 44 43 177 can also be contained in the dishwashing detergents according to the invention.

In a preferred embodiment of the invention, the dishwashing detergents contain acylated alkylenediamines, in particular tetraacetylethylenediamine (TAED), acylated glycolurils, in particular tetraacetylglycoluril (TAGU), acylated triazine derivatives, in particular 1,5-diacetyl-2,4-dioxohexahydro-1,3,5-triazine (DADHT), acylated phenylsulfonates, in particular nonanoyl-, isononanoyl- or lauroyloxybenzenesulfonate (NOBS, ISONOBS or LOBS) or their amido derivatives (e.g. NACAOBS), acylated hydroxycarboxylic acids such as acetylsalicylic acid or nonanoyloxybenzoic acid (NOBA) and decanoyloxy-benzoic acid (DOBA).

In a particularly preferred embodiment of the invention, the dishwashing detergents contain acylated alkylenediamines, in particular tetraacetylethylenediamine (TAED).

The dishwashing detergents according to the invention contain one or more bleach activators in an amount of 0.1 to 20% by weight, preferably 0.5 to 10% by weight, more preferably 0.5 to 8% by weight, and most preferably 1 to 6% by weight, in each case based on the total weight of the dishwashing detergents according to the invention.

In addition to builders a) and bleach activators b), the dishwashing detergents according to the invention contain non-ionic surfactants c).

These include alkoxylated, preferably ethoxylated and/or propoxylated, primary alcohols with preferably 8 to 18 carbon atoms and an average of 1 to 12 moles of ethylene oxide (EO) and 2 to 17 moles of ethylene oxide (EO)/propylene oxide (PO) per mole of alcohol, in which the alcohol residue can be linear or preferably methyl-branched in the 2-position or can contain linear and methyl-branched residues in the mixture, as they are usually present in oxoalcohol residues.

In particular, alcohol ethoxylates with linear residues from alcohols of native origin with 12 to 18 C atoms, e.g. from coconut, palm, tallow fat or oleyl alcohol, and an average of 2 to 8 EO per mol of alcohol are used, particularly preferred C₁₂-C₁₄ alcohols with 3 EO or 4 EO, C₉-C₁₁ alcohols with 7 EO, C₁₃-C₁₅ alcohols with 3 EO, 5 EO, 7 EO or 8 EO, C₁₂-C₁₈ alcohols with 3 EO, 5 EO or 7 EO and mixtures of these, such as mixtures of C₁₂-C₁₄ alcohol with 3 EO and C₁₂-C₁₈ alcohol with 7 EO, lauryl alcohol with 7 EO and 10 PO, lauryl alcohol with 2 EO and 4 PO, lauryl alcohol with 4 EO and 5 PO, lauryl alcohol with 5 EO and 4 PO, lauryl alcohol with 6 EO and 4 PO, lauryl alcohol with 8 EO and 4 PO, C₁₀-C₁₂ alcohol with 4 EO and 4 PO, isodecyl alcohol with 2 PO and 12 EO, isodecyl alcohol with 2 PO and 4 EO, undecyl alcohol with 8 EO and 2PO, C₁₂-C₁₅ oxoalcohol with 2EO and 5PO, C₁₂-C₁₅ oxoalcohol with 4EO and 4PO, C₁₂-C₁₅ oxoalcohol with 5PO and 2EO, C₁₂-C₁₅ oxoalcohol with 6EO and 4PO, C₁₂-C₁₅ oxoalcohol with 8EO and 4PO, C₆-C₁₂ alcohol with 6EO and 8PO.

The degrees of ethoxylation and degrees of propoxylation given above represent statistical mean values which may be an integer or a fractional number for a specific product.

The dishwashing detergents according to the invention may also contain alkyl glycosides of the general formula RO(G)ₓ, in which R is a primary straight-chain or methyl-branched, in particular methyl-branched in the 2-position, aliphatic radical having 8 to 22, preferably 12 to 18 carbon atoms, and G is a glycose unit having 5 or 6 carbon atoms, preferably glucose. The degree of oligomerization x, which indicates the distribution of monoglycosides and oligoglycosides, is an arbitrary number, which can also assume fractional values between 1 and 10 as a quantity to be determined analytically; preferably x is 1.2 to 1.4.

The dishwashing detergents according to the invention may also contain polyhydroxy fatty acid amides of the formula (VIII)

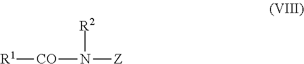

in which R¹—CO is an aliphatic acyl radical having 6 to 22 carbon atoms, R² is hydrogen, an alkyl or hydroxyalkyl radical having 1 to 4 carbon atoms and Z is a linear or branched polyhydroxyalkyl radical having 3 to 10 carbon atoms and 3 to 10 hydroxyl groups. Preferably, the polyhydroxy fatty acid amides are derived from reducing sugars with 5 or 6 carbon atoms, in particular from glucose.

The group of polyhydroxy fatty acid amides also comprises compounds of formula (IX)

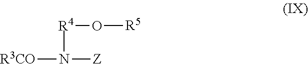

in which R³ is a linear or branched alkyl or alkenyl radical having 7 to 21 carbon atoms, R⁴ is a linear, branched or cyclic alkylene radical or an arylene radical having 6 to 8 carbon atoms and R⁵ is a linear, branched or cyclic alkyl radical or an aryl radical or an oxyalkyl radical having 1 to 8 carbon atoms, where C₁-C₄-alkyl or phenyl radicals are preferred, and Z is a linear polyhydroxyalkyl radical whose alkyl chain is substituted by at least two hydroxyl groups, or alkoxylated, preferably ethoxylated or propoxylated derivatives of this radical. Z is also preferably obtained here by reductive amination of a sugar such as glucose, fructose, maltose, lactose, galactose, mannose or xylose. The N-alkoxy- or N-allyloxy-substituted compounds can then be converted into the desired polyhydroxy fatty acid amides, for example by reaction with fatty acid methyl esters in the presence of an alkoxide as catalyst.

A further class of nonionic surfactants preferably used in the context of the present invention, which are used either as the sole nonionic surfactant or in combination with other nonionic surfactants, in particular together with alkoxylated fatty alcohols and/or alkyl glycosides, are alkoxylated, preferably ethoxylated or ethoxylated and propoxylated fatty acid alkyl esters, preferably with 1 to 4 carbon atoms in the alkyl chain, in particular fatty acid methyl esters.

Non-ionic surfactants of the amine oxide type, for example N-cocoalkyl-N,N-dimethyl-amine oxide and N-tallowalkyl-N,N-dihydroxyethylamine oxide and of the fatty acid alkanolamide type may also be suitable according to the invention.

The proportion of the one or more non-ionic surfactants in the total weight of the dishwashing detergents according to the invention is 0.1 to 20% by weight, preferably 0.1 to 10% by weight, particularly preferably 0.5 to 8% by weight, and most preferably 1 to 6% by weight.

In addition to builders a), bleach activators b) and non-ionic surfactants c), the dishwashing detergents according to the invention contain oxygen-containing bleaching agents d).

Bleaching agents are, on the one hand, oxygen-containing compounds which react with bleach activators to form peroxyacids which bleach much more effectively at low temperatures (e.g. <70° C.) than the bleaching agents alone.

Suitable bleaching agents of this type are hydrogen peroxide and inorganic persalts, preferably percarbonates, perborates, persulfates and persilicates, in particular in the form of alkali metal salts. Particularly preferred such bleaching agents are hydrogen peroxide, sodium perborate (monohydrate and tetrahydrate) and/or sodium percarbonate, in particular preferred sodium perborate (monohydrate and tetrahydrate) and/or sodium percarbonate.

In a preferred embodiment of the invention, the one or more bleaching agent d) is therefore selected from the group consisting of sodium perborate (monohydrate and tetrahydrate) and sodium percarbonate.

Oxygen-containing bleaching agents are, on the other hand, compounds that also work without a bleach activator. Suitable bleaching agents of this type are peracids or salts thereof.

Particularly preferred peracids or peracid salts are peroxycarboxylic acids and their salts according to the formula

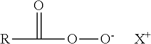

wherein R is an alkyl group, aralkyl group, cycloalkyl group, aryl group or heterocyclic group, preferably a linear or branched, substituted or unsubstituted alkyl group, in particular preferred an alkyl group having 6 to 9 carbon atoms, and X⁺ is a suitable counterion, preferably an H⁺, potassium or sodium ion. Preferred are peroxyhexanoylic acid, peroxyheptanoylic acid, peroxyoctanoylic acid, peroxynonanoylic acid, peroxydecanoylic acid and salts thereof.

Further particularly preferred peracids or peracid salts are peroxysulfonic acids and their salts according to the formula

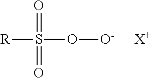

wherein R is an alkyl group, aralkyl group, cycloalkyl group, aryl group or heterocyclic group, preferably a linear or branched, substituted or unsubstituted alkyl group, in particular preferred an alkyl group having 6 to 9 carbon atoms, and X⁺ is a suitable counterion, preferably H⁺, a potassium or sodium ion.

Further particularly preferred peracids or peracid salts are peroxophthalic acids and their salts, phthaliminoperacids and their salts, diperoxy carboxylic acids and their salts or peroxy sulfuric acids and their salts.

Among the bleaching agents which act without bleach activator, particularly preferred are the peracids or their salts selected from the group consisting of monoperoxyphthalic acid and its salts, N,N-phthaloylaminoperoxycaproic acid (PAP) and its salts, diperazelaic acid and its salts, diperdodecanedioic acid and its salts and monoperoxy sulfuric acid and its salts, the salts being preferably selected from the sodium and/or potassium salts. Among monoperoxy sulfuric acid and its salts, potassium peroxy monosulfate (available under the trade name Caroat) is particularly preferred.

The amounts of bleaching agent used are generally selected so that between 10 ppm and 10% active oxygen, preferably between 50 ppm and 5000 ppm active oxygen, are present in the solutions of the compositions during the rinsing process when used as automatic dishwashing detergents.

The proportion of the one or more oxygen-containing bleaching agents in the total weight of the dishwashing detergents according to the invention is 5 to 40% by weight, preferably 5 to 30% by weight, particularly preferred 10 to 25% by weight, and very particularly preferred 10 to 20% by weight.

In addition to builders a), bleach activators b), non-ionic surfactants c) and oxygen-containing bleaching agents d), the dishwashing detergents according to the invention contain pH regulators e). These are required to adjust the application pH of the dishwashing detergents according to the invention to a value between 9 and 11. Preferably, the dishwashing detergents according to the invention contain alkali carbonates, in particular sodium carbonate, alkali hydrogen carbonates, alkali hydroxides, in particular potassium hydroxide and sodium hydroxide, disilicates and amino acids.

Also used are inorganic acids, for example mineral acids, e.g. hydrochloric acid, and organic acids, for example saturated or unsaturated mono-, di- and tricarboxylic acids and hydroxycarboxylic acids with one or more hydroxyl groups, e.g. citric acid, glycolic acid, lactic acid, maleic acid, formic acid and acetic acid, amidosulphuric acid, C₆-C₂₂ fatty acids and anion-active sulphonic acids, as well as mixtures thereof.

The proportion of the one or more pH regulators e) in the total weight of the dishwashing detergents according to the invention is 0.1 to 80% by weight, preferably 3 to 70% by weight, particularly preferably 5 to 60% by weight, and very particularly preferred 5 to 50% by weight.

In addition to builders a), bleach activators b), non-ionic surfactants c), oxygen-containing bleaching agents d) and pH regulators e), the dishwashing detergents according to the invention contain sulfonimines f).

The sulfonimines used according to the invention are compounds with one or two structural units ═N—SO₂— in the molecule.

These include sulfonimines of the formula I

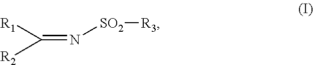

in which R₁ is hydrogen, alkyl, cycloalkyl, aryl, aralkyl or heterocyclyl, the alkyl, cycloalkyl, aryl, aralkyl or heterocyclyl radicals being unsubstituted or having one to three substituents selected from the group consisting of alkyl, alkoxy, aryl, heterocyclyl, amino, carboxyl carboxylic acid ester, carboxylic acid amide, sulfonyl, cyano, hydroxy or halogen, or in which an alkyl group is interrupted by one or more oxygen atoms which are not directly adjacent to one another or by one or more keto groups which are not directly adjacent to one another,
R₂ is hydrogen, alkyl, alkoxy, cycloalkyl, aryl, aralkyl, heterocyclyl, nitro, cyano, halogen, carboxyl, carboxylic acid ester or carboxylic acid amide, the alkyl, cycloalkyl, aryl, aralkyl or heterocyclyl radicals being unsubstituted or containing one to three substituents selected from the group consisting of alkyl, alkoxy, aryl, heterocyclyl, amino, hydroxyl, carboxyl, carboxylic acid ester, carboxylic acid amide, sulphonyl, cyano or halogen or wherein the alkyl, cycloalkyl, aryl or heterocyclyl radicals are substituted by a radical of the formula —R₁C═N—SO₂—R₃ or wherein an alkyl group is interrupted by one or more oxygen atoms which are not directly adjacent to one another or by one or more keto groups which are not directly adjacent to one another,
R₃ is alkyl, cycloalkyl, aryl, aralkyl, heterocyclyl, nitro, cyano or halogen, the alkyl, cycloalkyl, aryl, aralkyl or heterocyclyl radicals being unsubstituted or having one to three substituents selected from the group consisting of alkyl, alkoxy, aryl, heterocyclyl, amino, carboxyl, carboxylic acid ester, carboxylic acid amide, sulphonyl, cyano, hydroxyl or halogen, or in which an alkyl group is interrupted by one or more oxygen atoms which are not directly adjacent to one another or by one or more keto groups which are not directly adjacent to one another, or in which
R₁ and R₂ together with the carbon atom to which they are bonded form a cycloaliphatic, heterocyclic or carbocyclic-aromatic ring system which is unsubstituted or has one to three substituents selected from the group consisting of alkyl, alkoxy, aryl, heterocyclyl, amino, carboxyl, carboxylic acid ester, carboxylic acid amide, sulphonyl, cyano, hydroxy or halogen, or in which an alkyl group is substituted by one or more oxygen atoms or by one or more keto groups which are not directly adjacent to one another, or in which R₂ and R₃ together with the group —C═N—SO₂— via these are attached to one another form a heterocyclic ring system, which is unsubstituted or contains one to three substituents selected from the group consisting of alkyl, alkoxy, aryl, heterocyclyl, amino, carboxyl, carboxylic acid ester, carboxylic acid amide, sulphonyl, cyano, hydroxy or halogen or wherein an alkyl group is interrupted by one or more oxygen atoms or by one or more keto groups which are not directly adjacent to one another.

Preferably used sulfonimines are compounds of the formula (I) in which R₁ is hydrogen, R₂ is unsubstituted phenyl or phenyl substituted in the 4-position with carboxyl, chlorine, cyano, hydroxy or methoxy, and R₃ is unsubstituted phenyl or phenyl substituted in the 4-position with carboxyl, chlorine or nitro.

Particularly preferred sulfonimines are compounds of formula II

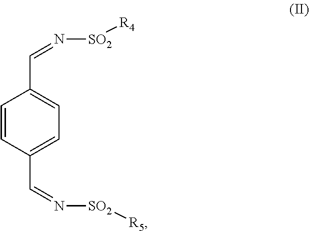

in which R₄ and R₅ independently of one another are unsubstituted phenyl or phenyl substituted in the 4-position with carboxyl, chlorine, cyano, hydroxyl or methoxy.

Further particularly preferred sulfonimines are compounds of formula III

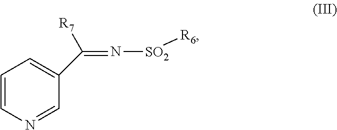

in which R₇ is hydrogen, C₁-C₆-alkyl or phenyl, and R₆ is unsubstituted phenyl or phenyl substituted in the 4-position with carboxyl, chlorine, cyano, hydroxyl or methoxy.

Particularly preferred sulfonimines are compounds of formula IV

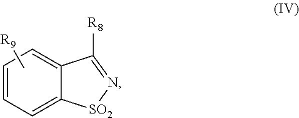

in which R₈ and R₉ independently of one another are hydrogen, C₁-C₆-alkyl or phenyl.

Of the compounds of formula IV, those in which R₉ is hydrogen and R₈ is C₁-C₆-alkyl, in particular methyl or ethyl, or phenyl, are particularly preferred.

A highly preferred sulfonimine of formula IV is 3-methyl-1,2-benzisothiazole-1,1-dioxide.

Further particularly preferred sulfonimines are compounds of the formula V

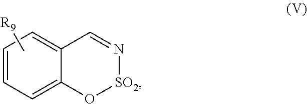

in which R₉ is hydrogen, C₁-C₆-alkyl or phenyl, in particular hydrogen.

The proportion of the one or more sulphonimines f) in the total weight of the dishwashing detergents according to the invention is 0.1 to 5% by weight, preferably 0.2 to 5% by weight, and most preferably 0.5 to 3% by weight.

If one of the radicals in this description is alkyl, the alkyl group can be either branched or unbranched. An alkyl group typically contains one to twenty carbon atoms, preferably one to ten carbon atoms. Examples of alkyl groups are: methyl, ethyl, n-propyl, isopropyl, n-butyl, sec.-butyl, tert.-butyl, pentyl, n-hexyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or eicosyl. Alkyl groups with one to six carbon atoms are particularly preferred.

Alkyl radicals may optionally be substituted, for example with alkyl, alkoxy, aryl, heterocyclyl, amino, hydroxy, carboxy, carboxylic acid ester, carboxylic acid amide, sulfonyl, cyano or halogen.

Alkyl radicals may be interrupted by one or more divalent oxygen atoms that are not directly adjacent to each other. Examples of this are monovalent radicals derived from polyethylene glycols or polypropylene glycols.

Alkyl radicals may also be interrupted by one or more keto groups that are not directly adjacent to each other. An example of this is the acetonyl residue.

If one of the radicals in this description means cycloalkyl, the cycloalkyl group is typically a cyclic group containing five to eight, preferably five, six or seven ring carbon atoms, each of which may be substituted independently of one another. Examples of substituents are given above in the description of alkyl groups. Examples of cycloalkyl groups are cyclopentyl or cyclohexyl.

If one of the radicals in this description is aryl, the aryl group is typically a cyclic aromatic group containing five to fourteen carbon atoms, each of which may be independently substituted. Examples of substituents are given above in the description of alkyl groups. Examples of aryl groups are phenyl, biphenyl or anthryl.

If one of the radicals in this description means heterocyclyl, the heterocyclyl group can typically be a cyclic group with four to ten ring carbon atoms and with at least one ring heteroatom, each of which can be substituted independently of one another. Examples of substituents are listed above in the description of the alkyl groups. Examples of heteroatoms are oxygen, nitrogen, phosphorus, boron, selenium or sulphur. Examples of heterocyclyl groups are furyl, thienyl, pyrrolyl or imidazolyl. Heterocyclyl groups can be aromatic or non-aromatic.

If one of the radicals in this description is aralkyl, the aralkyl group is typically an aryl group, where aryl has already been defined above, to which an alkyl group is covalently bonded. The aralkyl group may be substituted on the aromatic ring. Examples of substituents are listed above in the description of the alkyl groups. An example of an aralkyl group is benzyl.

If, in this description, one of the substituents means halogen, this is to be understood as a fluorine, chlorine, bromine or iodine atom. Preferred are fluorine, chlorine or bromine, in particular chlorine.

In a preferred embodiment, the dishwashing detergents according to the invention contain one or more enzymes selected from proteases, amylases, mannases, lipases, endolases, pectinases, cellulases, pullinases, cutinases or peroxidases.

Examples of proteases are Blaze Evity 150T, Liquanase® Ultra 2.0 XL, BLAP®, Opticlean®, Maxacal®, Maxapem®, Esperase®, Savinase®, Purafect®, OxP and/or Duraxym®.

Examples of amylases are Stainzyme Plus Evity 24T, Stainzyme® Plus 12 L, Termamyl®, Amylase® LT, Maxamyl®, Duramyl® and/or Purafect® Ox.

An example of a mannase is Mannaway 4.0 L.

Examples of lipases are Lipex® 100 L, Lipolase®, Lipomax®, Lumafast® and/or Lipozym®.

An example of an endolase is Endolase® 5000 L.

Examples of pectinases are Pectinex 3× L and/or Pectinex Ultra SPL.

Examples of cellulases are Carezyme 1000 L and/or Celluclast 1.5 L.

The proportion by weight of the one or more enzymes in the total weight of the dishwashing detergents according to the invention is preferably from 0.001 to 8% by weight, more preferably from 0.001 to 4.5% by weight and exceptionally preferred from 0.01 to 3.5% by weight.

In a further preferred embodiment, the dishwashing detergents according to the invention contain crystalline sodium phyllosilicate of formula (I) in the form of a compound comprising crystalline sodium phyllosilicate of formula (I) and an acidic component.

Preferably, the acidic component is a polycarboxylate, in particular a non-neutralized or only partially neutralized homopolymer and/or copolymer of acrylic acid, AMPS, methacrylic acid, maleic acid, polyaspartic acid, sugar carboxylic acid and/or other monomers. The molecular weight of the homopolymers and copolymers is preferably in the range from 1,000 to 100,000 g/mol, particularly preferably 2,000 to 50,000 g/mol. Acrylic acid/maleic acid copolymers with a molecular weight of 4,000 to 50,000 g/mol are particularly preferred. Copolymers of acrylic acid or methacrylic acid with vinyl ethers, such as vinyl methyl ether, vinyl ester, ethylene, propylene and styrene, are also preferred.

Commercially available products are, for example, Sokalan TM CP 5 and PA 30 from BASF, Alcosperse TM 175 or 177 from Alco and Acusol 45 N and Acusol 588G from Dow Chemicals.

The dishwashing detergents according to the invention may contain further components, such as electrolytes, silver corrosion inhibitors, foam regulators, compounds for increasing the drying performance of the dishes, compounds for preventing the formation of sieve residues during dishwashing, silicones, disintegrants, colorants and/or fragrances.

Dishwashing detergents containing compounds for increasing the drying performance of the dishes and for preventing the formation of sieve residues during dishwashing are known, for example, from EP 3 320 068 B1.

The dishwashing detergents according to the invention can contain phosphate or be phosphate-free.

In a preferred embodiment, the dishwashing detergents according to the invention are phosphate-free.

In order to achieve a bleaching effect, oxygen-containing bleaching agents, such as persalts, are added to the dishwashing detergents according to the invention. To activate these bleaching agents and to achieve a satisfactory bleaching effect, in particular at lower temperatures, the dishwashing detergents according to the invention also contain bleach activators b) and sulfonimines as bleaching catalysts f).

Bleach activators and/or bleach catalysts are preferably added to the dishwashing detergents according to the invention in the form of granules. This is done on the one hand to increase the storage stability of these ingredients and on the other hand to ensure homogeneous incorporation of minute amounts of bleach activator and bleach catalyst into the formulations.

Preferably, the bleach activators b) and bleach catalysts f) are contained in the dishwashing detergent according to the invention in the form of co-granulates.

In particular, these are co-granules coated with cellulose ether and containing
i) one or more sulfonimines f),
ii) one or more bleach activators b), and
iii) cellulose ether as a binder.

The sulfonimine f) is particularly preferably a cyclic sulfonimine.

A particularly preferred bleach activator b) is tetraacetyl-ethylenediamine and/or decanoyloxybenzoic acid.

Such co-granules are known from EP 3 874 949 A1.

Preferably, the co-granules contain a carboxymethylcellulose as binder iii).

Preferably, the co-granules are coated with methyl cellulose.

The dishwashing detergents according to the invention show very good cleaning performance when used, in particular in the removal of red and/or yellow soiling on household items, especially on plastic items.

The dishwashing detergents according to the invention can be present as powdery, granular or tablet-like preparations which can be produced in a conventional manner, for example by mixing, granulation, roller compaction and/or spray drying.

The dishwashing detergents according to the invention may also be present as liquid or gel formulations, which can be prepared in a conventional manner, for example by mixing the individual ingredients.

In addition, individual ingredients or combinations of ingredients can be introduced into multi-chamber containers which can be used directly in the dishwasher.

The dishwashing detergents according to the invention can be used for washing dishes by hand, but in particular as automatic dishwashing detergents.

The dishwashing detergents according to the invention can be used in processes for cleaning bathroom or kitchen articles, such as pots, bowls, dishes, glasses or baby articles. The method comprises bringing the dishwashing detergents according to the invention into contact with water and with the article to be cleaned, in particular with kitchen or baby articles, and allowing the aqueous cleaning liquid formed to act on the article to be cleaned.

The invention also relates to the use of the dishwashing detergents according to the invention for removing red and/or yellow soiling from household articles, in particular bathroom or kitchen articles. Household articles include those found in private households, but also those used in trade and industry, for example articles used in canteens or restaurants.

The dishwashing detergents according to the invention are preferably used to remove red and/or yellow soiling in industrial processes. This preferably involves the cleaning of plastic bottles, in particular polyethylene terepthalate bottles, for recycling.

### EXAMPLES

The following examples illustrate the invention without limiting it to this.

The composition of the dishwashing detergents used is shown in the following table.

| | formulation 1 | formulation 2 |
|---|---|---|
| | g/wash cycle | g/wash cylce |
| Sodium citrate | 7.2 | 7.2 |
| Sodium carbonate | 5.0 | 5.0 |
| Sodium percarbonate | 3.0 | 3.0 |
| Peractive ® AC white¹⁾ | 1.0 | 1.0 |
| Pluriol ® E 1500²⁾ | 0.6 | 0.6 |
| Pluriol ® E 6000³⁾ | 0.4 | 0.4 |
| Sokalan ® PA25 CI⁴⁾ | 1.0 | 1.0 |
| Lutensol ® TO 7⁵⁾ | 0.2 | 0.2 |
| Protease Blaze Evity 150T | 0.3 | 0.3 |
| Amylase Stainzyme Plus | 0.1 | 0.1 |
| Evity 24T | | |
| WeylClean ® SKS-6 WB⁶⁾ | 1.0 | 1.0 |
| WeylClean ® CC 30⁷⁾ | — | 0.3 |

¹⁾TAED bleach activator, WeylChem Wiesbaden, Wiesbaden
²⁾Polyethylene glycol, MW 1,500 g/mol, BASF, Ludwigshafen
³⁾Polyethylene glycol, MW 6,000 g/mol, BASF, Ludwigshafen
⁴⁾Polyacrylic acid, MW 4,000 g/mol, BASF, Ludwigshafen
⁵⁾non-ionic surfactant, ethoxylated iso-C₁₃-alcohol, BASF, Ludwigshafen
⁶⁾Builder, sodium layered disilicate (δ-Na₂Si₂O₅), WeylChem Wiesbaden, Wiesbaden
⁷⁾Bleaching catalyst, 3-methyl-1,2-benzisothiazole-1,1-dioxide, WeylChem Wiesbaden, Wiesbaden, Germany

### Performance of the Tests

At the beginning, the plastic parts used in the test were placed in a standard household dishwasher. In order to set the inlet water hardness in the machine to a constant and reproducible level, the ion exchanger installed in the machine at the factory was deactivated and the water set to a defined total water hardness was supplied via an external tank.

Initially, the plastic parts were pre-cleaned. For discoloration, 50 g of coloring soil was placed in the upper basket at the start of each rinse cycle. The test was carried out at 45° C. Between each rinse cycle, the machine was opened for 45 minutes to allow it to cool down completely.

During decolorization, 50 g of ballast soil was added to the upper basket for each rinse cycle. The test was carried out at 45° C. The machine was opened for 45 minutes between each wash cycle to allow it to cool down completely. After 1, 3 and 5 wash cycles, a visual assessment of the load parts for discoloration was carried out using a 4-point scale. In addition, the color shift (dE) of the cutting board was measured using Mach 5+.

The individual wash cycles were carried out under the following conditions:

| | | |
|---|---|---|
| Pre-cleaning | Machine type: | Miele GSL 2 |
| | Wash program: | 45° C., 8 min |
| | Rinse cycles: | 3 |
| | Water hardness: | 21°dH |
| | Product: | IEC-D |
| | Product dosage: | 20 g/rinse cycle |
| Test method | Coloring of plastic parts | |
| Test conditions | Machine type: | Miele GSL 2 |
| | Rinse program: | 45° C., 8 min |
| | Rinse cycles: | 5 |
| | Water hardness: | 21° dH |
| | Load soiling: | 50 g mustard |
| | | 50 g ketchup |
| | | 1 g turmeric |
| | | 1 g sunflower oil |
| Machine load - | 5 cans A/B (PP) | |
| | 5 cutting boards A/B (PE) | |
| | 5 funnels A/B (PP) | |
| | 5 baby teats A/B (PP/silicone) | |
| | 5 baby teat lids A/B (PP) | |
| Test method | Red Plastic Bleaching Test | |
| | Machine type: | Miele GSL 2 |
| | Rinse program: | 45° C., 8 min |
| | Rinse cycles: | 5 |
| | Water hardness: | 21° dH |
| Test conditions | Products: | Formulation 1 |
| | | Formulation 2 |
| | Product dosage: | 20 g/rinse cycle in dosing chamber |
| | Load soiling: | 50 g/rinse cycle, deep-frozen |
| | | (Composition following IKW Working |
| | | Group Method No. 3 of 27 Jun. 1997) |
| Machine load | 2 cans A/B (PP) | |
| | 2 cutting boards A/B (PE) | |
| | 2 funnels A/B (PP) | |
| | 2 baby teats A/B (PP/silicone) | |
| | 2 baby teat lids A/B (PP) | |

### Evaluation of the Results

Visual evaluation after 1, 3 and 5 cycles; four-point scale
   Score 0: no difference (to the colored initial value)
   Score 1: slight difference
   Score 2: clear difference
   Score 3: very clear difference

Measurement of the L*a*b* values using Mach5+ of the cutting board

### Visual Evaluation

The higher the score shown in the tables, the better the cleaning performance of the detergent.

### EXAMPLE 1

### Decolorization Test Using Formulation 1

The results of the visual assessment after five rinsing cycles are shown in the table below.

| Machine Load | | |
|---|---|---|
| Material | Type | Result of visual assessment |
| Plastic (PP) | Can, transparent | 2.0 |
| Plastic (PE) | Cutting board, white | 2.0 |
| Plastic (PP) | Funnel, white | 1.0 |
| Plastic (PP/Silicones) | Baby teat | 1.5 |
| Plastic (PP) | Baby teat lid | 2.0 |

### EXAMPLE 2

### Decolorization Test Using Formulation 2

The results of the visual assessment after carrying out five rinsing cycles are shown in the table below.

| Machine Load | | |
|---|---|---|
| Material | Type | Result of visual assessment |
| Plastic (PP) | Can, transparent | 2.0 |
| Plastic (PE) | Cutting board, white | 2.5 |
| Plastic (PP) | Funnel, white | 2.0 |
| Plastic (PP/Silicones) | Baby teat | 1.5 |
| Plastic (PP) | Baby teat lid | 2.0 |

### EXAMPLE 3

### Measurement of the Color Shift dE of the Cutting Boards Using Mach5+

The results after treatment with formulation 1 are shown in the table below.

| | | | Decoloration after | | | | | |
|---|---|---|---|---|---|---|---|---|
| Initial state | | | 5 cycles | | | dL | da | db |
| L1 | a1 | b1 | L2 | a2 | b2 | L2 − L1 | a2 − a1 | b2 − b1 |
| 85.21 | 1.99 | 6.86 | 85.10 | 3.17 | 7.44 | −0.11 | 1.18 | 0.58 |
| 85.74 | 1.86 | 5.76 | 86.25 | 1.3 | 5.20 | 0.51 | −0.56 | −0.56 |
| 85.35 | 1.88 | 6.60 | 86.07 | 1.36 | 5.26 | 0.72 | −0.52 | −1.34 |
| 85.35 | 1.88 | 6.60 | 86.04 | 1.58 | 5.63 | 0.69 | −0.30 | −0.97 |

| | | | |
|---|---|---|---|
| Average value | 0.45 | −0.05 | −0.57 |

| | |
|---|---|
| dE (average value) | 0.73 |

The results after treatment with formulation 2 are shown in the table below.

| | | | Decoloration after | | | | | |
|---|---|---|---|---|---|---|---|---|
| Initial state | | | 5 cycles | | | dL | da | db |
| L1 | a1 | b1 | L2 | a2 | b2 | L2 − L1 | a2 − a1 | b2 − b1 |
| 85.24 | 2.37 | 6.89 | 86.00 | 1.77 | 5.75 | 0.76 | −0.60 | −1.14 |
| 85.20 | 2.33 | 6.68 | 86.11 | 1.5 | 5.19 | 0.91 | −0.83 | −1.49 |
| 85.42 | 1.64 | 6.61 | 86.05 | 1.26 | 5.36 | 0.63 | −0.38 | −1.25 |
| 85.20 | 2.33 | 6.68 | 85.92 | 1.81 | 5.53 | 0.72 | −0.52 | −1.15 |

| | | | |
|---|---|---|---|
| Average value | 0.75 | −0.58 | −1.26 |

| | |
|---|---|
| dE (average value) | 1.58 |

The lower the number, the less pronounced the color change.

1. A dishwashing detergent comprising the components
a) 10-90% by weight of at least one builder;
b) 0.1-20% by weight of at least one bleach activator;
c) 0.1-20% by weight of at least one non-ionic surfactant;
d) 5-40% by weight of at least one oxygen-containing bleaching agent;
e) 0.1-80% by weight of at least one pH regulator, and
f) 0.1-5% by weight of at least one sulfonimine as bleaching catalyst,
with the proviso that the dishwashing detergent does not contain substantially any anionic surfactant and that the percentages relate to the total amount of the dishwashing detergent.

2. The dishwashing detergent according to claim 1, wherein the builder is selected from the group consisting of crystalline sodium layered silicate and/or polymeric polycarboxylic acid.

3. The dishwashing detergent according to claim 2, wherein the detergent contains as component a) a compound comprising crystalline sodium layered silicate and polymeric polycarboxylic acid.

4. The dishwashing detergent according to claim 1, wherein the bleach activator b) is selected from the group consisting of acylated alkylenediamines, acylated glycolurils, acylated triazine derivatives and acylated phenylsulfonates.

5. The dishwashing detergent according to claim 4, wherein the bleach activator is at least one of tetraacetylethylenediamine (TAED), tetraacetylglycoluril (TAGU), 1,5-diacetyl-2,4-dioxohexahydro-1,3,5-triazine (DADHT), nonanoyl-, isononanoyl- or lauroyloxybenzene-sulfonate (NOBS, ISONOBS or LOBS) or their amido derivatives, NACAOBS, acetylsalicylic acid, nonanoyloxybenzoic acid (NOBA) and decanoyloxybenzoic acid (DOBA).

6. The dishwashing detergent according to claim 1, wherein the nonionic surfactant c) is selected from the group consisting of alkoxylated fatty alcohols having ten to twenty carbon atoms, alkoxylated fatty acids having ten to twenty carbon atoms, ethoxylated fatty alcohols having ten to twenty carbon atoms and ethoxylated fatty acids having ten to twenty carbon atoms.

7. The dishwashing detergent according to claim 1, wherein the oxygen-containing bleaching agent d) is selected from the group consisting of sodium perborate (monohydrate and tetrahydrate) and sodium percarbonate.

8. The dishwashing detergent according to claim 1, wherein the pH regulator e) is selected from the group consisting of alkali metal carbonates, alkali metal hydrogen carbonates, alkali metal hydroxides, potassium hydroxide, sodium hydroxide, sodium acetate, disilicates and amino acids.

9. The dishwashing detergent according to claim 1, wherein the bleaching catalyst f) is a sulfonimine of formula I 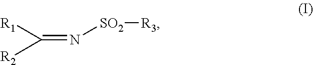
in which R₁ is hydrogen, alkyl, cycloalkyl, aryl, aralkyl or heterocyclyl, the alkyl, cycloalkyl, aryl, aralkyl or heterocyclyl radicals having zero to three substituents selected from the group consisting of alkyl, alkoxy, aryl, heterocyclyl, amino, carboxyl carboxylic acid ester, carboxylic acid amide, sulfonyl, cyano, hydroxy, halogen, an alkyl group which is interrupted by one or more oxygen atoms which are not directly adjacent to one another, and by one or more keto groups which are not directly adjacent to one another,
R₂ is hydrogen, alkyl, alkoxy, cycloalkyl, aryl, aralkyl, heterocyclyl, nitro, cyano, halogen, carboxyl, carboxylic acid ester or carboxylic acid amide, the alkyl, cycloalkyl, aryl, aralkyl, heterocyclyl radicals having zero to three substituents selected from the group consisting of alkyl, alkoxy, aryl, heterocyclyl, amino, hydroxyl, carboxyl, carboxylic acid ester, carboxylic acid amide, sulphonyl, cyano, halogen, or wherein the alkyl, cycloalkyl, aryl or heterocyclyl radicals are substituted by a radical of the formula —R₁C═N—SO₂—R₃ or wherein an alkyl group is interrupted by one or more oxygen atoms which are not directly adjacent to one another or by one or more keto groups which are not directly adjacent to one another,
R₃ is alkyl, cycloalkyl, aryl, aralkyl, heterocyclyl, nitro, cyano or halogen, the alkyl, cycloalkyl, aryl, aralkyl or heterocyclyl radicals having zero to three substituents selected from the group consisting of alkyl, alkoxy, aryl, heterocyclyl, amino, carboxyl, carboxylic acid ester, carboxylic acid amide, sulphonyl, cyano, hydroxyl or halogen, or wherein an alkyl group is interrupted by one or more oxygen atoms which are not directly adjacent to one another or by one or more keto groups which are not directly adjacent to one another;
optionally, R₁ and R₂ together with the carbon atom to which they are bonded form a cycloaliphatic, heterocyclic or carbocyclic-aromatic ring system which has zero to three substituents selected from the group consisting of alkyl, alkoxy, aryl, heterocyclyl, amino, carboxyl, carboxylic acid ester, carboxylic acid amide, sulphonyl, cyano, hydroxy or halogen, further wherein an alkyl group is substituted by one or more oxygen atoms or by one or more keto groups which are not directly adjacent to one another;
optionally R₂ and R₃ together with the group —C═N—SO₂— are attached to one another form a heterocyclic ring system, having zero to three substituents selected from the group consisting of alkyl, alkoxy, aryl, heterocyclyl, amino, carboxyl, carboxylic acid ester, carboxylic acid amide, sulphonyl, cyano, hydroxy, halogen or wherein an alkyl group is interrupted by one or more oxygen atoms or by one or more keto groups which are not directly adjacent to one another.

10. The dishwashing detergent according to claim 1, wherein the bleaching catalyst f) is a sulfonimine of formula IV 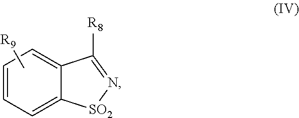
in which R₈ and R₉ independently of one another are hydrogen, C₁-C₆-alkyl or phenyl.

11. The dishwashing detergent according to claim 1 wherein the dishwashing detergent contains one or more enzymes selected from the group consisting of proteases, amylases, mannases, lipases, endolases, pectinases, cellulases, pullinases, cutinases and/or peroxidases.

12. The dishwashing detergent according to claim 1 wherein the dishwashing detergent contains crystalline sodium layered silicate of the formula (I) and an acidic component in the form of a mixture.

13. The dishwashing detergent according to claim 1 wherein the dishwashing detergent further contains electrolytes, silver corrosion inhibitors, foam regulators, compounds for increasing the drying performance of the dishes, compounds for preventing the formation of sieve residues during dishwashing, silicones, disintegrants, dyes and fragrances.

14. The dishwashing detergent according to claim 1 wherein the bleach activators b) and bleach catalysts f) are added to the dishwashing detergent in the form of granules.

15. The dishwashing detergent according to claim 14, wherein the bleach activators b) and bleach catalysts f) are contained in the dishwashing detergent in the form of co-granulates.

16. The dishwashing detergent according to claim 15, wherein the co-granules are co-granules coated with cellulose ether containing
i) one or more sulfonimines f),
ii) one or more bleach activators b), and
iii) cellulose ether as a binder.

17. The dishwashing detergent according to claim 16, wherein the sulfonimine f) is a cyclic sulphonimine and the bleach activator b) is selected from tetraacetylethylene-diamine and decanoyloxybenzoic acid.

18. The dishwashing detergent according to claim 15, wherein the co granulates contain a carboxymethylcellulose as binder iii) and are coated with methylcellulose.

19. A method of using the dishwashing detergent of claim 1 comprising contacting an article having red or yellow soiling, with the detergent and water, for a time sufficient to remove the red or yellow soiling from the article and rinsing the article with water to remove the soiling.

20. (canceled)

21. The method of claim 19 wherein the detergent is employed in an industrial process for cleaning of plastic bottles.
